(19) United States
(12) Patent Application Publication
(10) Pub. No.: US 2013/0190432 A1
(43) Pub. Date: Jul. 25, 2013

(54) Flame Retardant-Stabilizer Combination For Thermoplastic Polymers

(71) Applicants: Werner Krause, Huerth (DE); Harald Bauer, Kerpen (DE); Martin Sicken, Koeln (DE); Sebastian Hoerold, Diedorf (DE); Wolfgang Wanzke, Augsburg (DE); Elke Schlosser, Augsburg (DE)

(72) Inventors: Werner Krause, Huerth (DE); Harald Bauer, Kerpen (DE); Martin Sicken, Koeln (DE); Sebastian Hoerold, Diedorf (DE); Wolfgang Wanzke, Augsburg (DE); Elke Schlosser, Augsburg (DE)

(73) Assignee: CLARIANT FINANCE (BVI) LIMITED, Tortola (VG)

(21) Appl. No.: 13/878,145

(22) PCT Filed: Sep. 30, 2011
(86) PCT No.: PCT/EP11/04887

§ 371 Date: Apr. 5, 2013

(30) Foreign Application Priority Data
Oct. 9, 2010 (DE) 10 2010 048 025.8

(51) Int. Cl. C08K 5/5313; C08K 5/3492; C08K 5/10; C08K 3/22; C08K 5/5317; C08K 5/56; C08K 5/52; C08K 3/38

(52) U.S. Cl. CPC C08K 5/5313; C08K 5/52; C08K 5/34922; C08K 5/34924; C08K 3/38; C08K 3/22; C08K 5/5317; C08K 5/56; C08K 5/10
USPC 524/101; 106/431; 106/503; 106/502; 106/471; 524/139; 524/100; 524/133

(57) ABSTRACT

A novel flame retardant-stabilizer combination for thermoplastic polymers, comprising as component A 20 to 99% by weight of a dialkylphosphinic salt of the formula (I) and/or of a diphosphinic salt of the formula (II) and/or polymers thereof in which R¹, R² are the same or different and are each C₁-C₆-alkyl, linear or branched; R³ is C₁-C₁₀-alkylene, linear or branched, C₆-C₁₀-arylene, C₇-C₂₀-alkylarylene or C₇-C₂₀-arylalkylene; M is Mg, Ca, Al, Sb, Sn, Ge, Ti, Zn, Fe, Zr, Ce, Bi, Sr, Mn, Li, Na, K and/or a protonated nitrogen base; m is 1 to 4; n is 1 to 4; x is 1 to 4, as component B 1 to 80% by weight of a salt of the phosphorous acid with the general formula (III) [HP(═O)O₂]²⁻M^{m+} (III) in which M is Mg, Ca, Al, Sb, Sn, Ge, Ti, Zn, Fe, Zr, Ce, Bi, Sr, Mn, Li, Na and/or K and m is 1 to 4, as component C 0 to 30% by weight of a nitrogen-containing synergist and/or of a phosphorus/nitrogen flame retardant, as component D 0 to 10% by weight of a zinc salt and/or of a basic or amphoteric oxide, hydroxide, carbonate, silicate, borate, stannate, mixed oxide hydroxide, oxide hydroxide carbonate, hydroxide silicate and/or hydroxide borate and/or mixtures of these substances, as component E 0 to 3% by weight of a phosphonite and/or of a mixture of a phosphonite and a phosphite, and as component F 0 to 3% by weight of an ester and/or salt of long-chain aliphatic carboxylic acids (fatty acids) which typically have chain lengths of C₁₄ to C₄₀, where the sum of the components is always 100% by weight.

The invention relates to a flame retardant-stabilizer combination for thermoplastic polymers and to polymeric molding compositions and moldings which comprise such flame retardant-stabilizer combinations.

Thermoplastic polymers are processed predominantly in the melt. Barely any polymer withstands the associated changes in structure and state without any change in its chemical structure. Crosslinking, oxidation, changes in molecular weight and hence also changes in the physical and technical properties may be the result. In order to reduce stress on the polymers during processing, different additives are added according to the polymer.

Different additives are often used at the same time, each of which takes on a particular task. For instance, antioxidants and stabilizers are used in order that the polymer withstands processing without chemical damage and then has a sufficient period of stability with respect to outside influences such as heat, UV light, weathering and oxygen (air). In addition to improving flow characteristics, lubricants prevent excessive adhesion of the polymer melt to hot machine parts and act as a dispersant for pigments, fillers and reinforcers.

The use of flame retardants can influence the stability of polymers in the course of processing in the melt. Flame retardants frequently have to be added in high dosages in order to ensure sufficient flame retardancy of the polymer according to international standards. Due to their chemical reactivity, which is required for flame retardancy at high temperatures, flame retardants can impair the processing stability of polymers. This may result, for example, in increased polymer degradation, crosslinking reactions, outgassing or discoloration.

Polyamides are stabilized, for example, by small amounts of copper halides and aromatic amines, and sterically hindered phenols, with emphasis on the achievement of long-term stability at high sustained use temperatures (H. Zweifel (ed.): “Plastics Additives Handbook”, 5^{th} Edition, Carl Hanser Verlag, Munich, 2000, pages 80 to 84).

Especially for thermoplastic polymers, the salts of phosphinic acids (phosphinates) have been found to be effective flame-retardant additives (DE-A-2 252 258 and DE-A-2 447 727). Calcium phosphinates and aluminum phosphinates have been described as particularly effective in polyesters and impair the material properties of the polymer molding compositions to a lesser degree than, for example, the alkali metal salts (EP-A-0 699 708). In addition, synergistic combinations of phosphinates with particular nitrogen-containing compounds have been found, and these have been found to be more effective as flame retardants in a whole series of polymers than the phosphinates alone (PCT/EP97/01664, and also DE-A-19 734 437 and DE-A-19 737 727).

Polymer molding compositions with phosphorus-containing flame retardants can be stabilized with carbodiimides, isocyanates and isocyanurates (DE-A-19 920 276).

Especially in the case of use of phosphorus-containing flame retardants in polyamides, the efficacy of the stabilizers described to date has been found to be inadequate, specifically for countering the effects which occur in the course of processing, such as discoloration and decreasing molecular weight.

DE-A-19 614 424 describes phosphinates in conjunction with nitrogen synergists in polyesters and polyamides. DE-A-19 933 901 describes phosphinates in combination with melamine polyphosphate as a flame retardant for polyesters and polyamides. In the case of use of these very effective flame retardants, however, there may be partial polymer degradation and discoloration of the polymer, especially at processing temperatures above 300° C., and exudation in the course of storage under moist and warm conditions.

EP-A-0 964 886 describes flame-retardant polyester and polyamide molding compositions which comprise, as a flame retardant, an aluminum phosphinate in combination with an aluminum hydroxide, an aluminum phosphate and/or an aluminum phosphonate. In a polybutylene terephthalate with 30% glass fibers, the flame retardant mixture comprising aluminum phosphinate and aluminum hydroxide in 20% dosage attains UL 94 V-2, that comprising aluminum phosphinate and aluminum phosphate UL 94 V-1, and that comprising aluminum phosphinate and aluminum monomethylphosphonate V-0. The elongation at break measured is 1.2%. For industrial applications, in injection molding, however, significantly higher elongations at break of at least 2% are required, in order that the ejector pins of the injection molding machines do not damage the components.

It was therefore an object of the present invention to provide flame retardant-stabilizer combinations for thermoplastic polymers, especially for polyamides and polyesters, which, as well as flame retardancy, also have good mechanical values and low polymer degradation, exert a stabilizing effect on the polymer, do not lead to mold deposits and do not lead to exudation from the polymers. Moreover, the inventive flame retardant-stabilizer combinations lead to better values for elongation at break.

This object is achieved by a mixture of a salt of a dialkylphosphinic acid (component A) with a salt of phosphorous acid (also referred to as phosphonic acid) HP(═O)(OH)₂ (component B) and optionally one or more further nitrogen- or phosphorus/nitrogen-containing flame retardants (component C), and optionally further components.

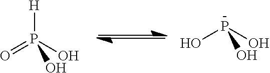

Phosphorous acid, tautomeric forms (defined hereinafter as component B) with the formula (III) [HP(═O)(O₂]²⁻M^{m+}.

The invention therefore provides a flame retardant-stabilizer combination for thermoplastic polymers, comprising as component A 20 to 99% by weight of a dialkylphosphinic salt of the formula (I) and/or of a diphosphinic salt of the formula (II) and/or polymers thereof

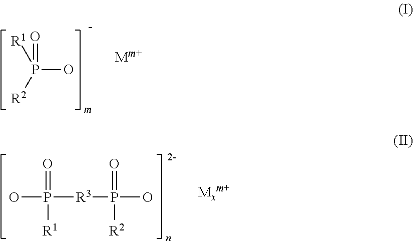

in which
R¹, R² are the same or different and are each linear or branched C₁-C₆-alkyl;
R³ is linear or branched C₁-C₁₀-alkylene, C₆-C₁₀-arylene, C₇-C₂₀-alkylarylene or C₇-C₂₀-arylalkylene;
M is Mg, Ca, Al, Sb, Sn, Ge, Ti, Zn, Fe, Zr, Ce, Bi, Sr, Mn, Li, Na, K and/or a protonated nitrogen base;
m is 1 to 4;
n is 1 to 4;
x is 1 to 4,

as component B 1 to 80% by weight of a salt of phosphorous acid having the formula (III)

[HP(═O)O₂]²⁻M^{m+} (III)

in which
M is Mg, Ca, Al, Sb, Sn, Ge, Ti, Zn, Fe, Zr, Ce, Bi, Sr, Mn, Li, Na and/or K;
m is 1 to 4,

as component C 0 to 30% by weight of a nitrogen-containing synergist and/or of a phosphorus/nitrogen flame retardant,

as component D 0 to 10% by weight of a zinc salt and/or of a basic and/or amphoteric oxide, hydroxide, carbonate, silicate, borate, stannate, mixed oxide-hydroxide, oxide-hydroxide-carbonate, hydroxide-silicate and/or hydroxide-borate and/or mixtures of these substances,

as component E 0 to 3% by weight of a phosphonite and/or of a mixture of a phosphonite and a phosphite, and as component F 0 to 3% by weight of an ester and/or salt of long-chain aliphatic carboxylic acids (fatty acids) which typically have chain lengths of C₁₄ to C₄₀, where the sum of the components is always 100% by weight.

It has been found that, surprisingly, inventive combinations of salts of dialkylphosphinic acids with salts of phosphorous acid have good flame retardancy combined with improved stability on incorporation into the polymers. Polymer degradation is prevented or very greatly reduced and no mold deposits or exudation are observed. The inventive combinations additionally reduce the discoloration of the polymers in the course of processing in the melt and suppress the degradation of the polymers to units of lower molecular weight.

Preferably, R¹, R² are the same or different and are each methyl, ethyl, n-propyl, isopropyl, n-butyl, tert-butyl, n-pentyl and/or phenyl.

Preferably, R³ is methylene, ethylene, n-propylene, isopropylene, n-butylene, tert-butylene, n-pentylene, n-octylene or n-dodecylene; phenylene or naphthylene; methylphenylene, ethylphenylene, tert-butylphenylene, methylnaphthylene, ethylnaphthylene or tert-butylnaphthylene; phenylmethylene, phenylethylene, phenylpropylene or phenylbutylene.

The flame retardant-stabilizer combination preferably comprises

60 to 89.9% by weight of component A,

10 to 40% by weight of component B,

0 to 30% by weight of component C,

0 to 15% by weight of component D,

0 to 2% by weight of component E and

0.1 to 2% by weight of component F.

The flame retardant-stabilizer combination preferably also comprises

60 to 84.9% by weight of component A,

10 to 40% by weight of component B,

5 to 30% by weight of component C,

0 to 10% by weight of component D,

0 to 2% by weight of component E and

0.1 to 2% by weight of component F.

The flame retardant-stabilizer combination preferably also comprises

60 to 84.8% by weight of component A,

10 to 40% by weight of component B,

5 to 30% by weight of component C,

0 to 10% by weight of component D,

0.1 to 2% by weight of component E and

0.1 to 2% by weight of component F.

Component B preferably comprises reaction products of phosphorous acid with aluminum compounds.

Component B preferably comprises aluminum phosphite [Al(H₂PO₃)₃], secondary aluminum phosphite [Al₂(HPO₃)₃], basic aluminum phosphite [Al(OH)(H₂PO₃)₂*2aq], aluminum phosphite tetrahydrate [Al₂(HPO₃)₃*4aq], aluminum phosphonate, Al₇(HPO₃)₉(OH)₆(1,6-hexanediamine)_{1.5}*12H₂O, Al₂(HPO₃)³*xAl₂O₃*nH₂O where x=2.27-1 and/or Al₄H₆P₁₆O₁₈.

Component C preferably comprises condensation products of melamine and/or reaction products of melamine with polyphosphoric acid and/or reaction products of condensation products of melamine with polyphosphoric acid or mixtures thereof.

Component C preferably comprises melem, melam, melon, dimelamine pyrophosphate, melamine polyphosphate, melem polyphosphate, melam polyphosphate, melon polyphosphate and/or mixed poly salts thereof.

Component C preferably comprises nitrogen-containing phosphates of the formulae (NH₄)_{y}H_{3-y}PO₄ and (NH₄ PO₃)_{z}, where y is 1 to 3 and z is 1 to 10 000.

Component D preferably comprises magnesium oxide, calcium oxide, aluminum oxide, zinc oxide, manganese oxide, tin oxide, aluminum hydroxide, boehmite, dihydrotalcite, hydrocalumite, magnesium hydroxide, calcium hydroxide, zinc hydroxide, tin oxide hydrate, manganese hydroxide, zinc borate, basic zinc silicate and/or zinc stannate.

The phosphonites are preferably those of the structure

R—[P(OR₁)₂]ₘ (IV)

where
R is a mono- or polyvalent aliphatic, aromatic or heteroaromatic organic radical and
R₁ is a compound of the structure (V)

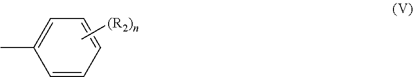

or the two R₁ radicals form a bridging group of the structure (VI)

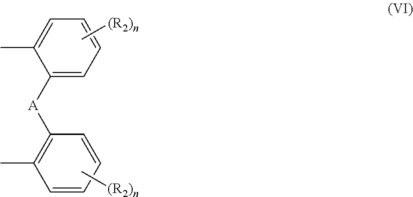

where
A is a direct bond, O, S, C₁-C₁₈-alkylene (linear or branched), C₁-C₁₈-alkylidene (linear or branched), in which
   R₂ is independently C₁-C₁₂-alkyl (linear or branched), C₁-C₁₂-alkoxy, C₅-C₁₂-cycloalkyl and
   n is 0 to 5 and
   m is 1 to 4.

Component F preferably comprises alkali metal, alkaline earth metal, aluminum and/or zinc salts of long-chain fatty acids having 14 to 40 carbon atoms and/or reaction products of long-chain fatty acids having 14 to 40 carbon atoms with polyhydric alcohols such as ethylene glycol, glycerol, trimethylolpropane and/or pentaerythritol.

The invention also relates to a flame-retardant polymer molding composition comprising a flame retardant-stabilizer combination as claimed in one or more of claims 1 to 14, wherein the polymer comprises thermoplastic polymers and/or elastomers of the HI (high-impact) polystyrene, polyphenylene ether, polyamide, polyester or polycarbonate type, and blends or polymer blends of the ABS (acrylonitrile-butadiene-styrene) or PC/ABS (polycarbonate/acrylonitrile-butadiene-styrene) or PPE/HIPS (polyphenylene ether/HI polystyrene) polymer type, and the polymer molding composition comprises the flame retardant-stabilizer combination of claims 1 to 14 in an amount of 2 to 50% by weight, based on the polymer molding composition.

The invention likewise relates to polymer moldings, films, filaments and fibers comprising a flame retardant-stabilizer combination as claimed in one or more of claims 1 to 14, wherein the polymer comprises HI (high-impact) polystyrene, polyphenylene ethers, polyamides, polyesters or polycarbonates, and blends or polymer blends of the ABS (acrylonitrile-butadiene-styrene) or PC/ABS (polycarbonate/acrylonitrile-butadiene-styrene) type, polyamide, polyester and/or ABS and/or elastomers, and these comprise the flame retardant-stabilizer combination of claims 1 to 14 in an amount of 2 to 50% by weight, based on the polymer moldings, films, filaments and fibers.

The polymer more preferably comprises polyamides and/or polyesters.

Preferred salts of phosphorous acid (component B) are water-insoluble or sparingly water-soluble salts.

Particularly preferred salts of phosphorous acid are aluminum, calcium and zinc salts.

More preferably, component B is a reaction product of phosphorous acid and an aluminum compound.

Preference is given to aluminum phosphites having the CAS numbers 15099-32-8, 119103-85-4, 220689-59-8, 56287-23-1, 156024-71-4, 71449-76-8 and 15099-32-8.

Preference is given to aluminum phosphites of the Al₂(HPO₃)₃*0.1-30Al₂O₃*0-50 H₂O type, more preferably Al₂(HPO₃)₃*0.2-20 Al₂O₃*0-50 H₂O, most preferably Al₂(HPO₃)₃*1-3 Al₂O₃*0-50 H₂O.

Preference is given to mixtures of aluminum phosphite and aluminum hydroxide having the composition of 5-95% by weight of Al₂(HPO₃)₃*nH₂O and 95-5% by weight of Al(OH)₃, more preferably 10-90% by weight of Al₂(HPO₃)₃*nH₂O and 90-10% by weight of Al(OH)₃, most preferably 35-65% by weight of Al₂(HPO₃)₃*nH₂O and 65-35% by weight of Al(OH)₃ and in each case n=0 to 4.

The aluminum phosphites preferably have particle sizes of 0.2 to 100 μm.

The preferred aluminum phosphites are typically prepared by reaction of an aluminum source with a phosphorus source and optionally a template in a solvent at 20 to 200° C. over a period of time of up to 4 days. For this purpose, aluminum source and phosphorus source are mixed, heated under hydrothermal conditions or at reflux, filtered off, washed and dried.

Preferred aluminum sources are aluminum isopropoxide, aluminum nitrate, aluminum chloride, aluminum hydroxide (e.g. pseudoboehmite).

Preferred phosphorus sources are phosphorous acid, (acidic) ammonium phosphite, alkali metal phosphites or alkaline earth metal phosphites.

Preferred alkali metal phosphites are disodium phosphite, disodium phosphite hydrate, trisodium phosphite, potassium hydrogenphosphite.

A preferred disodium phosphite hydrate is Brüggolen® H10 from Brüggemann.

Preferred templates are 1,6-hexanediamine, guanidine carbonate or ammonia.

A preferred alkaline earth metal phosphite is calcium phosphite.

The preferred ratio of aluminum to phosphorus to solvent is 1:1:3.7 to 1:2.2:100 mol. The ratio of aluminum to template is 1:0 to 1:17 mol.

The preferred pH of the reaction solution is 3 to 9.

A preferred solvent is water.

Also in accordance with the invention are flame retardant-stabilizer combinations comprising

50 to 95% by weight of component A,

5 to 50% by weight of component B,

0 to 30% by weight of component C,

0 to 15% by weight of component D,

0 to 2% by weight of component E and

0 to 2% by weight of component F.

Also in accordance with the invention are flame retardant-stabilizer combinations comprising

50 to 94.9% by weight of component A,

5 to 50% by weight of component B,

0 to 30% by weight of component C,

0 to 15% by weight of component D,

0 to 2% by weight of component E and

0.1 to 2% by weight of component F.

Also in accordance with the invention are flame retardant-stabilizer combinations comprising

50 to 94.8% by weight of component A,

5 to 50% by weight of component B,

0 to 30% by weight of component C,

0 to 15% by weight of component D,

0.1 to 2% by weight of component E and

0.1 to 2% by weight of component F.

Also in accordance with the invention are flame retardant-stabilizer combinations comprising

50 to 94.8% by weight of component A,

5 to 30% by weight of component B,

5 to 20% by weight of component C,

0 to 15% by weight of component D,

0.1 to 2% by weight of component E and

0.1 to 2% by weight of component F.

Also in accordance with the invention are flame retardant-stabilizer combinations comprising

50 to 94.7% by weight of component A,

5 to 30% by weight of component B,

5 to 20% by weight of component C,

0.1 to 15% by weight of component D,

0.1 to 2% by weight of component E and

0.1 to 2% by weight of component F.

Component C is preferably melamine cyanurate.

Component C preferably comprises ammonium hydrogenphosphate, ammonium dihydrogenphosphate and/or ammonium polyphosphate.

Suitable components C are also compounds of the formulae (VII) to (XII) or mixtures thereof

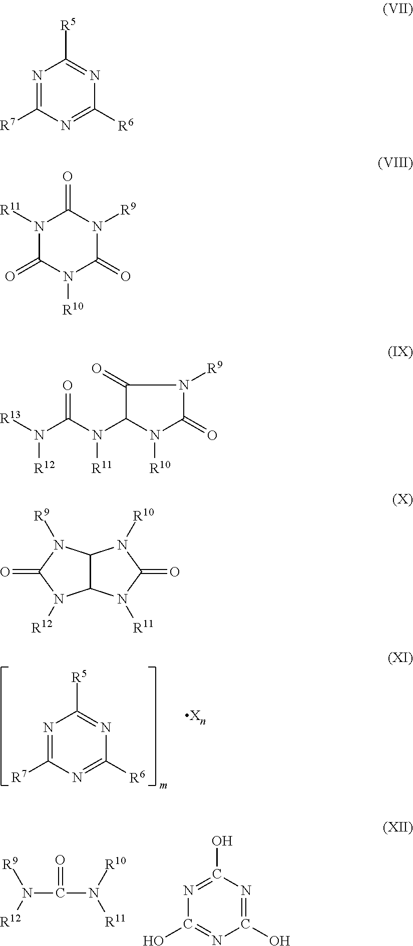

in which
R⁵ to R⁷ are each hydrogen, C₁-C₈-alkyl, C₅-C₁₆-cycloalkyl or -alkylcycloalkyl, possibly substituted by a hydroxyl function or a C₁-C₄-hydroxyalkyl function, C₂-C₈-alkenyl, C₁-C₈-alkoxy, -acyl, -acyloxy, C₆-C₁₂-aryl or -arylalkyl, —OR⁸ and —N(R⁸)R⁹, and also N-alicyclically or N-aromatically,
R⁸ is hydrogen, C₁-C₈-alkyl, C₅-C₁₆-cycloalkyl or -alkylcycloalkyl, possibly substituted by a hydroxyl function or a C₁-C₄-hydroxyalkyl function, O₂-C_{g}-alkenyl, C₁-C₈-alkoxy, -acyl, -acyloxy or C₆-C₁₂-aryl or -arylalkyl,
R⁹ to R¹³ are the same groups as R⁸, and also —O—R⁸,
m and n are each independently 1, 2, 3 or 4,
X denotes acids which can form adducts with triazine compounds (VII);
   or oligomeric esters of tris(hydroxyethyl)isocyanurate with aromatic polycarboxylic acids.

Particularly suitable components C are benzoguanamine, tris(hydroxyethyl)isocyanurate, allantoin, glycoluril, melamine, melamine cyanurate, dicyandiamide and/or guanidine.

More preferably, component D comprises boehmite, dihydrotalcite, zinc borate and/or zinc stannate.

M is preferably calcium, aluminum or zinc.

Protonated nitrogen bases are preferably understood to mean the protonated bases of ammonia, melamine, triethanolamine, especially NH₄⁺.

Suitable phosphinates are described in PCT/WO97/39053, which is explicitly incorporated by reference.

Particularly preferred phosphinates are aluminum, calcium and zinc phosphinates.

In the application, particular preference is given to using the same salt of phosphinic acid as of phosphorous acid, i.e., for example, aluminum dialkylphosphinate together with aluminum phosphite or zinc dialkylphosphinate together with zinc phosphite.

Additives may be added to the inventive combination of components A and B and optionally C, D, E and F, for example antioxidants, UV absorbers and light stabilizers, metal deactivators, peroxide-destroying compounds, polyamide stabilizers, basic costabilizers, nucleating agents, fillers, reinforcers, further flame retardants and other additions.

Suitable antioxidants are, for example, alkylated monophenols, e.g. 2,6-di-tert-butyl-4-methylphenol; 1,2-alkylthiomethylphenols, e.g. 2,4-dioctylthiomethyl-6-tert-butylphenol; hydroquinones and alkylated hydroquinones, e.g. 2,6-di-tert-butyl-4-methoxyphenol; tocopherols, e.g. α-tocopherol, β-tocopherol, γ-tocopherol, δ-tocopherol and mixtures thereof (vitamin E); hydroxylated thiodiphenyl ethers, e.g.

2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide; alkylidenebisphenols, e.g. 2,2′-methylenebis(6-tert-butyl-4-methylphenol); O-, N- and S-benzyl compounds, e.g. 3,5,3′,5′-tetra-tert-butyl-4,4′-dihydroxydibenzyl ether; hydroxybenzylated malonates, e.g. dioctadecyl 2,2-bis(3,5-di-tert-butyl-2-hydroxybenzyl)malonate; hydroxybenzyl aromatics, e.g. 1,3,5-tris(3,5-di-tert-butyl)-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol; triazine compounds, e.g. 2,4-bisoctylmercapto-6-(3,5-di-tert-butyl-4-hydroxyanilino)-1,3,5-triazine; benzyl phosphonates, e.g. dimethyl 2,5-di-tert-butyl-4-hydroxybenzylphosphonate; acylaminophenols, 4-hydroxylauramide, 4-hydroxystearanilide, N-(3,5-di-tert-butyl-4-hydroxyphenyl)carbamic acid octyl ester; esters of β-(3,5-di-tert-butyl-4-hydroxyphenyl)propionic acid with mono- or polyhydric alcohols; esters of β-(5-tert-butyl-4-hydroxy-3-methylphenyl)propionic acid with mono- or polyhydric alcohols; esters of β-(3,5-dicyclohexyl-4-hydroxyphenyl)propionic acid with mono- or polyhydric alcohols; esters of 3,5-di-tert-butyl-4-hydroxyphenylacetic acid with mono- or polyhydric alcohols; amides of β-(3,5-di-tert-butyl-4-hydroxyphenyl)propionic acid, for example N,N′-bis(3,5-di-tert-butyl-4-hydroxyphenylpropionyl)hexamethylenediamine, N,N′-bis(3,5-di-tert-butyl-4-hydroxyphenylpropionyl)trimethylenediamine, N,N′-bis(3,5-di-tert-butyl-4-hydroxyphenylpropionyl)hydrazine.

Suitable UV absorbers and light stabilizers are, for example, 2-(2′-hydroxyphenyl)benzotriazoles, for example 2-(2′-hydroxy-5′-methylphenyl)benzotriazole;

2-hydroxybenzophenones, for example the 4-hydroxy, 4-methoxy, 4-octoxy, 4-decyloxy, 4-dodecyloxy, 4-benzyloxy, 4,2′,4-trihydroxy, 2′-hydroxy-4,4′-dimethoxy derivative;

esters of optionally substituted benzoic acids, for example 4-tert-butylphenyl salicylate, phenyl salicylate, octylphenyl salicylate, dibenzoylresorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate; acrylates, for example ethyl or isooctyl α-cyano-β,β-diphenylacrylate, methyl α-carbomethoxycinnamate, methyl or butyl α-cyano-β-methyl-p-methoxycinnamate, methyl α-carbomethoxy-p-methoxycinnamate, N-(β-carbomethoxy-β-cyanovinyl)-2-methylindoline.

In addition, nickel compounds, for example nickel complexes of 2,2′-thiobis-[4-(1,1,3,3-tetramethylbutyl)phenol], such as the 1:1 or the 1:2 complex, optionally with additional ligands such as n-butylamine, triethanolamine or N-cyclohexyldiethanolamine, nickel dibutyldithiocarbamate, nickel salts of 4-hydroxy-3,5-di-tert-butylbenzylphosphonic acid monoalkyl esters, such as those of the methyl or ethyl ester, nickel complexes of ketoximes, such as those of 2-hydroxy-4-methylphenyl undecyl ketoxime, nickel complexes of 1-phenyl-4-lauroyl-5-hydroxypyrazole, optionally with additional ligands; sterically hindered amines, for example bis(2,2,6,6-tetramethylpiperidyl)sebacate; oxalamides, for example 4,4′-dioctyloxyoxanilide; 2-(2-hydroxyphenyl)-1,3,5-triazines, for example 2,4,6-tris(2-hydroxy-4-octyloxyphenyl)-1,3,5-triazine.

Suitable metal deactivators are, for example, N,N′-diphenyloxalamide, N-salicylal-N′-salicyloylhydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalic dihydrazide, oxanilide, isophthalic dihydrazide, sebacic bisphenylhydrazide, N,N′-diacetyladipic dihydrazide, N,N′-bis(salicyloyl)oxalic dihydrazide, N,N′-bis(salicyloyl)thiopropionic dihydrazide.

Suitable peroxide-destroying compounds are, for example, esters of 3-thiodipropionic acid, for example the lauryl, stearyl, myristyl or tridecyl esters, mercaptobenzimidazole, the zinc salt of 2-mercaptobenzimidazole, zinc dibutyldithiocarbamate, dioctadecyl disulfide, pentaerythrityl tetrakis(β-dodecylmercapto)propionate.

Suitable polyamide stabilizers are, for example, copper salts in combination with iodides and/or phosphorus compounds and salts of divalent manganese.

Suitable basic costabilizers are melamine, polyvinylpyrrolidone, dicyandiamide, triallyl cyanurate, urea derivatives, hydrazine derivatives, amines, polyamides, polyurethanes, alkali metal and alkaline earth metal salts of higher fatty acids, for example calcium stearate, zinc stearate, magnesium behenate, magnesium stearate, sodium ricinoleate, potassium palmitate, antimony catecholate or tin catecholate.

Suitable nucleating agents are, for example, 4-tert-butylbenzoic acid, adipic acid and diphenylacetic acid.

Examples of fillers and reinforcers include calcium carbonate, silicates, glass fibers, asbestos, talc, kaolin, mica, barium sulfate, metal oxides and hydroxides, carbon black, graphite and others.

Suitable further flame retardants are, for example, aryl phosphates, phosphonates, salts of hypophosphorous acid and red phosphorus.

The other additions include, for example, plasticizers, expandable graphite, lubricants, emulsifiers, pigments, optical brighteners, flame retardants, antistats, blowing agents.

These additional additives can be added to the polymers before, together with or after addition of the flame retardants. These additives, and also the flame retardants, can be dosed in solid form, in a solution or melt, or else in the form of solid or liquid mixtures or as masterbatches/concentrates.

In the case of the phosphonites, the radicals are preferably:
R C₄-C₁₈-alkyl (linear or branched), C₄-C₁₈-alkylene (linear or branched), C₅-C₁₂-cycloalkyl, C₅-C₁₂-cycloalkylene, C₆-C₂₄-aryl or heteroaryl, C₆-C₂₄-arylene or heteroarylene, which may also have further substitution;
R₁ a compound of the structure (IX) or (X) where
R₂ independently C₁-C₈-alkyl (linear or branched), C₁-C₈-alkoxy, cyclohexyl;
A a direct bond, O, C₁-C₈-alkylene (linear or branched), C₁-C₈-alkylidene (linear or branched) and
n 0 to 3;
m 1 to 3.

In the case of the phosphonites, the radicals are more preferably:
R cyclohexyl, phenyl, phenylene, biphenyl and biphenylene;
R₁ a compound of the structure (IX) or (X) where
R₂ independently C₁-C₈-alkyl (linear or branched), C₁-C₈-alkoxy, cyclohexyl;
A a direct bond, O, C₁₋C₆-alkylidene (linear or branched) and
n 1 to 3;
m 1 or 2.

Additionally claimed are mixtures of compounds according to the above claims in combination with phosphites of the formula (XIII)

P(OR₁)₃ (XIII)

where R₁ is as defined above.

Especially preferred are compounds which, based on the above information, are prepared by a Friedel-Crafts reaction of an aromatic or heteroaromatic, such as benzene, biphenyl or diphenyl ether, with phosphorus trihalides, preferably phosphorus trichloride, in the presence of a Friedel-Crafts catalyst such as aluminum chloride, zinc chloride, iron chloride etc., and subsequent reaction with the phenols underlying the structures (IX) and (X). Also explicitly included are those mixtures with phosphites which form according to the reaction sequence mentioned from excess phosphorus trihalide and the above-described phenols.

From this group of compounds, preference is given in turn to the following structures (XIV) and (XV):

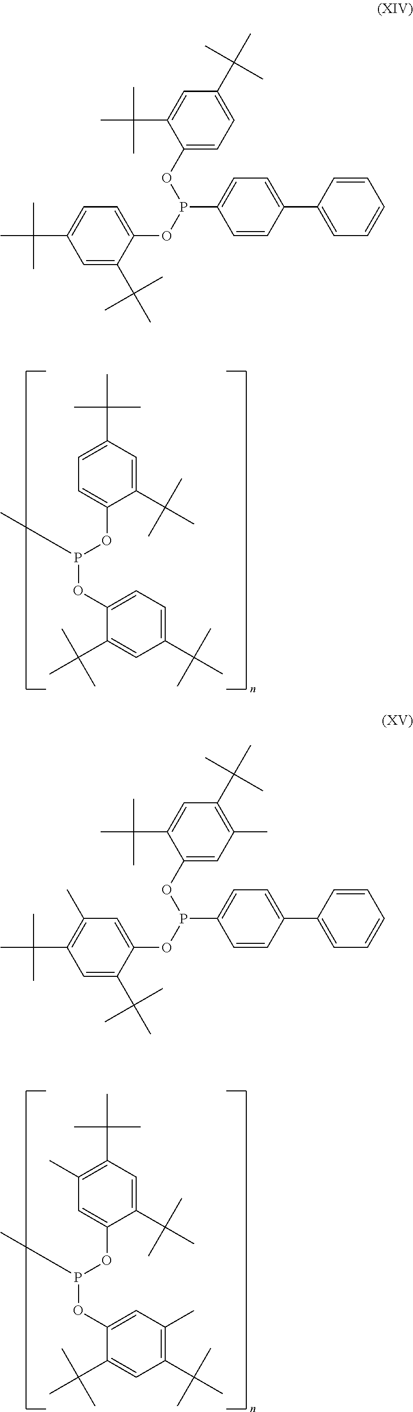

where n may be 0 or 1 and these mixtures may optionally further comprise proportions of the compound (XVI) and/or (XVII):

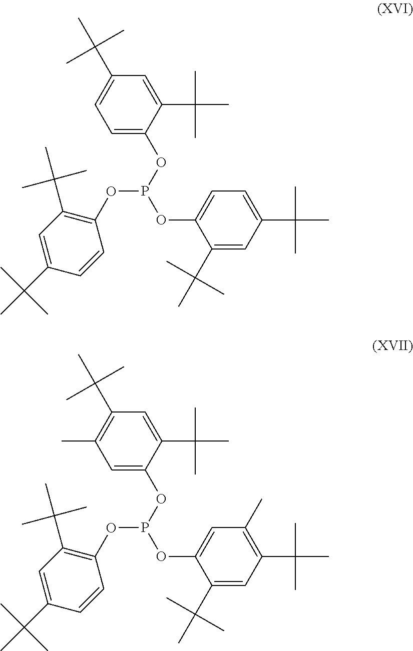

Suitable components F are esters or salts of long-chain aliphatic carboxylic acids (fatty acids) which typically have chain lengths of C₁₄ to C₄₀. The esters are reaction products of the carboxylic acids mentioned with standard polyhydric alcohols, for example ethylene glycol, glycerol, trimethylolpropane or pentaerythritol. Useful salts of the carboxylic acids mentioned are in particular alkali metal or alkaline earth metal salts or aluminum and zinc salts.

Preferred components F are esters or salts of stearic acid, for example glyceryl monostearate or calcium stearate.

Component F preferably comprises reaction products of montan wax acids with ethylene glycol.

The reaction products are more preferably a mixture of ethylene glycol mono-montan wax ester, ethylene glycol di-montan wax ester, montan wax acids and ethylene glycol.

Component F preferably comprises reaction products of montan wax acids with a calcium salt.

The reaction products are more preferably a mixture of 1,3-butanediol mono-montan wax ester, 1,3-butanediol di-montan wax ester, montan wax acids, 1,3-butanediol, calcium montanate and the calcium salt.

The ratios of components A, B and optionally C in the flame retardant-stabilizer combination depend essentially on the envisaged field of use and can vary within wide limits. According to the field of use, the flame retardant-stabilizer combination contains 20 to 99% by weight of component A, 1 to 80% by weight of component B and 0 to 30% by weight of component C. Components D, E and F are each independently added in 0 to 3% by weight.

The polymer more preferably comprises polyamides, polyesters and PPE/HIPS blends.

Preference is given to using the flame retardant-stabilizer combination in the polymer molding composition in a total amount of 2 to 50% by weight, based on the polymer molding composition. The total amount of the polymer molding composition is then 50 to 98% by weight.

Particular preference is given to using the flame retardant-stabilizer combination in the polymer molding composition in a total amount of 10 to 30% by weight, based on the polymer molding composition. The total amount of the polymer molding composition is then 70 to 90% by weight.

The polymer moldings, films, filaments and fibers preferably comprise the flame retardant-stabilizer combination in a total amount of 2 to 50% by weight, based on the polymer content. The amount of polymer is then 50 to 98% by weight.

The polymer moldings, films, filaments and fibers more preferably comprise the flame retardant-stabilizer combination in a total amount of 10 to 30% by weight, based on the polymer content. The amount of polymer is then 70 to 90% by weight.

The aforementioned additives can be introduced into the polymer in a wide variety of different process steps. For instance, it is possible in the case of polyamides or polyesters, at the start or at the end of the polymerization/polycondensation or in a subsequent compounding operation, to mix the additives into the polymer melt. In addition, there are processing operations in which the additives are not added until a later stage. This is practiced especially in the case of use of pigment or additive masterbatches. There is also the possibility of applying additives, particularly in pulverulent form, to the polymer pellets, which may be warm as a result of the drying operation, by drum application.

The flame retardant-stabilizer combination is preferably in the form of pellets, flakes, fine grains, powder and/or micronizate.

The flame retardant-stabilizer combination is preferably in the form of a physical mixture of the solids, of a melt mixture, of a compactate, of an extrudate, or in the form of a masterbatch.

The inventive flame retardant-stabilizer combination can be used in thermoplastic polymers.

Suitable polyesters derive from dicarboxylic acids and esters thereof and diols and/or from hydroxycarboxylic acids or the corresponding lactones. Particular preference is given to using terephthalic acid and ethylene glycol, propane-1,3-diol and butane-1,3-diol.

Suitable polyesters include polyethylene terephthalate, polybutylene terephthalate (Celanex® 2500, Celanex® 2002, from Celanese; Ultradur®, from BASF), poly-1,4-dimethylolcyclohexane terephthalate, polyhydroxybenzoates, and block polyether esters which derive from polyethers with hydroxyl end groups; and also polyesters modified with polycarbonates or MBS.

The flame-retardant polyester molding compositions produced in accordance with the invention are preferably used in polyester moldings.

Preferred polyester moldings are filaments, fibers, films and moldings themselves, which comprise mainly terephthalic acid as the dicarboxylic acid components and mainly ethylene glycol as the diol component.

Preferably, the resulting phosphorus content in filaments and fibers produced from flame-retardant polyester is 0.1 to 18%, preferably 0.5 to 15%, and, in the case of films, 0.2 to 15%, preferably 0.9 to 12% by weight.

Suitable polystyrenes are polystyrene, poly(p-methylstyrene) and/or poly(alpha-methylstyrene).

The suitable polystyrenes are preferably copolymers of styrene or alpha-methylstyrene with dienes or acrylic derivatives, for example styrene-butadiene, styrene-acrylonitrile, styrene-alkyl methacrylate, styrene-butadiene-alkyl acrylate and methacrylate, styrene-maleic anhydride, styrene-acrylonitrile-methyl acrylate; more impact-resistant mixtures of styrene copolymers and another polymer, for example a polyacrylate, a diene polymer or an ethylene-propylene-diene terpolymer; and block copolymers of styrene, for example styrene-butadiene-styrene, styrene-isoprene-styrene, styrene-ethylene/butylene-styrene or styrene-ethylene/propylene-styrene.

The suitable polystyrenes are preferably also graft copolymers of styrene or alpha-methylstyrene, for example styrene onto polybutadiene, styrene onto polybutadiene-styrene or polybutadiene-acrylonitrile copolymers, styrene and acrylonitrile (or methacrylonitrile) onto polybutadiene; styrene, acrylonitrile and methyl methacrylate onto polybutadiene; styrene and maleic anhydride onto polybutadiene; styrene, acrylonitrile and maleic anhydride or maleimide onto polybutadiene; styrene and maleimide onto polybutadiene, styrene and alkyl acrylates or alkyl methacrylates onto polybutadiene, styrene and acrylonitrile onto ethylene-propylene-diene terpolymers, styrene and acrylonitrile onto polyalkyl acrylates or polyalkyl methacrylates, styrene and acrylonitrile onto acrylate-butadiene copolymers, and mixtures thereof, as known, for example, as what are called ABS, MBS, ASA or AES polymers.

The polymers are preferably polyamides and copolyamides which derive from diamines and dicarboxylic acids and/or from aminocarboxylic acids or the corresponding lactams, such as nylon-2,12, nylon-4, nylon-4,6, nylon-6, nylon-6,6, nylon-6,9, nylon-6,10, nylon-6,12, nylon-6,66, nylon-7,7, nylon-8,8, nylon-9,9, nylon-10,9, nylon-10,10, nylon-11, nylon-12, etc. These are known, for example, by the trade names Nylon®, from DuPont, Ultramid®, from BASF, Akulon® K122, from DSM, Zytel® 7301, from DuPont; Durethan® B 29, from Bayer and Grillamid®, from Ems Chemie.

Also suitable are aromatic polyamides proceeding from m-xylene, diamine and adipic acid; polyamides prepared from hexamethylenediamine and iso- and/or terephthalic acid and optionally an elastomer as a modifier, for example poly-2,4,4-trimethylhexamethyleneterephthalamide or poly-m-phenyleneisophthalamide, block copolymers of the aforementioned polyamides with polyolefins, olefin copolymers, ionomers or chemically bound or grafted elastomers, or with polyethers, for example with polyethylene glycol, polypropylene glycol or polytetramethylene glycol. In addition, EPDM- or ABS-modified polyamides or copolyamides; and polyamides condensed during processing (“RIM polyamide systems”).

The invention finally also relates to a process for producing flame-retardant polymer moldings, wherein inventive flame-retardant polymer molding compositions are processed by injection molding (for example injection molding machine of the Aarburg Allrounder type) and pressing, foam injection molding, internal gas pressure injection molding, blow molding, film casting, calendering, laminating or coating at elevated temperatures to give the flame-retardant polymer molding.

Preferably, the thermoset polymers comprise unsaturated polyester resins (UP resins) which derive from copolyesters of saturated and unsaturated dicarboxylic acids or anhydrides thereof with polyhydric alcohols, and vinyl compounds as crosslinking agents. UP resins are cured by free-radical polymerization with initiators (e.g. peroxides) and accelerators.

Preferred unsaturated dicarboxylic acids and derivatives for preparation of the polyester resins are maleic anhydride and fumaric acid.

Preferred saturated dicarboxylic acids are phthalic acid, isophthalic acid, terephthalic acid, tetrahydrophthalic acid, adipic acid.

Preferred diols are 1,2-propanediol, ethylene glycol, diethylene glycol and neopentyl glycol, neopentyl glycol, ethoxylated or propoxylated bisphenol A.

A preferred vinyl compound for crosslinking is styrene.

Preferred curative systems are peroxides and metal coinitiators, for example hydroperoxides and cobalt octanoate and/or benzoyl peroxide and aromatic amines and/or UV light and photosensitizers, e.g. benzoin ethers.

Preferred hydroperoxides are di-tert-butyl peroxide, tert-butyl peroctoate, tert-butyl perpivalate, tert-butyl per-2-ethylhexanoate, tert-butyl permaleate, tert-butyl perisobutyrate, benzoyl peroxide, diacetyl peroxide, succinyl peroxide, p-chlorobenzoyl peroxide and dicyclohexyl peroxodicarbonate.

Preferably, initiators are used in amounts of 0.1 to 20% by weight, preferably 0.2 to 15% by weight, based on the mass of all comonomers.

Preferred metal coinitiators are compounds of cobalt, manganese, iron, vanadium, nickel or lead. Preferably, metal coinitiators are used in amounts of 0.05 to 1% by weight, based on the mass of all comonomers.

Preferred aromatic amines are dimethylaniline, dimethyl-p-toluene, diethylaniline and phenyldiethanolamine.

In one process for producing flame-retardant thermoset compositions, a thermoset resin is mixed with an inventive flame retardant-stabilizer combination as claimed in one or more of claims 1 to 16 and optionally further flame retardants, synergists, stabilizers, additives and fillers or reinforcers, and the resulting mixture is wet pressed at pressures of 3 to 10 bar and temperatures of 20 to 60° C. (cold pressing).

In a further process for producing flame-retardant thermoset compositions, a thermoset resin is mixed with an inventive flame retardant-stabilizer combination as claimed in one or more of claims 1 to 16 and optionally further flame retardants, synergists, stabilizers, additives and fillers or reinforcers, and the resulting mixture is wet pressed at pressures of 3 to 10 bar and temperatures of 80 to 150° C. (warm or hot pressing).

Preferably, the polymers are crosslinked epoxy resins which derive from aliphatic, cycloaliphatic, heterocyclic or aromatic glycidyl compounds, for example from bisphenol A diglycidyl ethers and bisphenol F diglycidyl ethers, which are crosslinked by means of customary hardeners and/or accelerators.

Suitable glycidyl compounds are bisphenol A diglycidyl esters, bisphenol F diglycidyl esters, polyglycidyl esters of phenol formaldehyde resins and cresol-formaldehyde resins, polyglycidyl esters of phthalic acid, isophthalic acid and terephthalic acid, and of trimellitic acid, N-glycidyl compounds of aromatic amines and heterocyclic nitrogen bases, and di- and polyglycidyl compounds of polyhydric aliphatic alcohols.

Suitable hardeners are aliphatic, cycloaliphatic, aromatic and heterocyclic amines or polyamines, such as ethylenediamine, diethylenetriamine, triethylenetetramine, propane-1,3-diamine, hexamethylenediamine, aminoethylpiperazine, isophoronediamine, polyamidoamine, diaminodiphenylmethane, diaminodiphenyl ether, diaminodiphenyl sulfone, aniline-formaldehyde resins, 2,2,4-trimethylhexane-1,6-diamine, m-xylylenediamine, bis(4-aminocyclohexyl)methane, 2,2-bis(4-aminocyclohexyl)propane, 3 aminomethyl-3,5,5-trimethylcyclohexylamine (isophoronediamine), polyamidoamines, cyanoguanidine and dicyandiamide, and likewise polybasic acids or anhydrides thereof, for example phthalic anhydride, maleic anhydride, tetrahydrophthalic anhydride, methyltetrahydrophthalic anhydride, hexahydrophthalic anhydride and methylhexahydrophthalic anhydride, and also phenols, for example phenol-novolac resin, cresol-novolac resin, dicyclopentadiene-phenol adduct resin, phenol aralkyl resin, cresolaralkyl resin, naphtholaralkyl resin, biphenol-modified phenolaralkyl resin, phenol-trimethylolmethane resin, tetraphenylolethane resin, naphthol-novolac resin, naphthol-phenol cocondensate resin, naphthol-cresol cocondensate resin, biphenol-modified phenol resin and aminotriazine-modified phenol resin. All hardeners can be used alone or in combination with one another.

Suitable catalysts or accelerators for the crosslinking in the polymerization are tertiary amines, benzyldimethylamine, N-alkylpyridines, imidazole, 1-methylimidazole, 2-methylimidazole, 2-ethyl-4-methylimidazole, 2-ethyl-4-methylimidazole, 2-phenylimidazole, 2-heptadecylimidazole, metal salts of organic acids, Lewis acids and amine complex salts.

The formulation of the invention may also comprise other additives which are commonly used in epoxy resin formulations, such as pigments, dyes and stabilizers.

Epoxy resins are suitable for potting of electrical or electronic components and for saturation and impregnation processes. In electrical engineering, epoxy resins are predominantly rendered flame-retardant and used for printed circuit boards and insulators.

Preferably, the polymers are crosslinked polymers which derive from aldehydes on the one hand, and phenols, urea or melamine on the other hand, such as phenol-formaldehyde, urea-formaldehyde and melamine-formaldehyde resins. The polymers preferably comprise crosslinkable acrylic resins which derive from substituted acrylic esters, for example from epoxy acrylates, urethane acrylates or polyester acrylates.

Preferably, the polymers are alkyd resins, polyester resins and acrylate resins which have been crosslinked with melamine resins, urea resins, isocyanates, isocyanurates, polyisocyanates or epoxy resins.

Preferred polyols are alkene oxide adducts of ethylene glycol, 1,2-propanediol, bisphenol A, trimethylolpropane, glycerol, pentaerythritol, sorbitol, sugars, degraded starch, ethylenediamine, diaminotoluene and/or aniline, which serve as initiators. The preferred alkoxylating agents preferably contain 2 to 4 carbon atoms, particular preference being given to ethylene oxide and propylene oxide.

Preferred polyester polyols are obtained by polycondensation of a polyalcohol such as ethylene glycol, diethylene glycol, propylene glycol, 1,4-butanediol, 1,5-pentanediol, methylpentanediol, 1,6-hexanediol, trimethylolpropane, glycerol, pentaerythritol, diglycerol, glucose and/or sorbitol, with a dibasic acid such as oxalic acid, malonic acid, succinic acid, tartaric acid, adipic acid, sebacic acid, maleic acid, fumaric acid, phthalic acid and/or terephthalic acid. These polyester polyols can be used alone or in combination.

Suitable polyisocyanates are aromatic, alicyclic or aliphatic polyisocyanates having not fewer than two isocyanate groups and mixtures thereof. Preference is given to aromatic polyisocyanates such as tolyl diisocyanate, methylene diphenyl diisocyanate, naphthylene diisocyanate, xylylene diisocyanate, tris(4-isocyanatophenyl)methane and polymethylenepolyphenylene diisocyanates; alicyclic polyisocyanates such as methylenediphenyl diisocyanate, tolyl diisocyanate; aliphatic polyisocyanates and hexamethylene diisocyanate, isophorone diisocyanate, dimeryl diisocyanate, 1,1-methylenebis(4-isocyanatocyclohexane-4,4′-diisocyanatodicyclohexylmethane isomer mixture, 1,4-cyclohexyl diisocyanate, Desmodur® products (Bayer) and lysine diisocyanate and mixtures thereof.

Suitable polyisocyanates are modified products which are obtained by reaction of polyisocyanate with polyol, urea, carbodiimide and/or biuret.

Preferably, the weight ratio of the polyisocyanate to polyol is 170 to 70 parts by weight, preferably 130 to 80 parts by weight, based on 100 parts by weight of the polyol.

Preferably, the weight ratio of the catalyst is 0.1 to 4 parts by weight, more preferably 1 to 2 parts by weight, based on 100 parts by weight of the polyol.

The polymers are preferably thermoplastic elastomers.

Thermoplastic elastomers (abbreviation: TPE) are materials which are thermoplastically processible and have rubber-like use properties. Thermoplastic elastomers can be shaped very easily, since they pass through the plastic state in the course of processing. They can be produced in all hardnesses from 5 Shore A to more than 70 Shore D. Thermoplastic elastomers have, in partial ranges, physical crosslinking points which break down with heating, without decomposition of the macromolecules. Therefore, they have much better processibility than normal elastomers. Thus, the polymer wastes can also be melted again and processed further.

According to internal structure, a distinction is made between block copolymers and elastomer alloys.

Block copolymers have hard and soft segments within one molecule. The polymer thus consists of one type of molecule in which both properties are distributed. Elastomer alloys are polyblends, i.e. mixtures (blends) of finished polymers, i.e. the polymer consists of two or more molecule types. Through different mixing ratios and additives, tailored materials are obtained (for example polyolefin elastomer formed from polypropylene (PP) and natural rubber (NR)—according to the ratio, they cover a wide hardness range).

A distinction is made between the following groups:
TPE-O or TPO=olefin-based thermoplastic elastomers, predominantly PP/EPDM, e.g. Santoprene® (AES/Monsanto)
TPE-V or TPV=crosslinked olefin-based thermoplastic elastomers, predominantly PP/EPDM, e.g. Sarlink® (DSM)
TPE-U or TPU=urethane-based thermoplastic elastomers, e.g. Desmopan® (Bayer)
TPE-E or TPC=thermoplastic copolyesters, e.g. Hytrel® (DuPont)
TPE-S or TPS=styrene block copolymers (SBS, SEBS, SEPS, SEEPS and MBS), e.g. Septon® (Kuraray) or Thermolast® (Kraiburg TPE)
TPE-A or TPA=thermoplastic copolyamides, e.g. PEBAX® (Arkema)

Particularly preferred thermoplastic elastomers are thermoplastic copolyesters, thermoplastic copolyamides and thermoplastic polyurethanes.

Preference is given to using the mixture in a molding composition of a polyamide or of a polyester. Suitable polyamides are described, for example, in DE-A-19 920 276.

The polyamides are preferably those of the amino acid type and/or of the diamine-dicarboxylic acid type.

Preferred polyamides are nylon-6 and/or nylon-6,6.

The polyamides are preferably unmodified, colored, filled, unfilled, reinforced, unreinforced, or else differently modified.

The polyesters are preferably polyethylene terephthalate or polybutylene terephthalate.

The polyesters are preferably unmodified, colored, filled, unfilled, reinforced, unreinforced, or else differently modified.

### EXAMPLES

1. Components Used

Commercial Polymers (Pellets):

Nylon-6,6 (N 6,6-GR): Ultramid® A27 (from BASF AG, Germany)

Nylon-6T/6,6: Zytel® HTN FE 8200 (from DuPont, USA)

Polybutylene terephthalate (PBT): Ultradur® B4500 (from BASF AG, Germany)

Nylon-4,6: Stanyl® PA 46 TE 300 (DSM, the Netherlands)

Vetrotex® 983 EC 10 4.5 mm glass fibers (from Saint-Gobain-Vetrotex, Germany)

Vetrotex® 952 EC 10 4.5 mm glass fibers (from Saint-Gobain-Vetrotex, Germany)

Vetrotex® 995 EC 10 4.5 mm glass fibers (from Saint-Gobain-Vetrotex, Germany)

Flame Retardant (Component A):

aluminum salt of diethylphosphinic acid, referred to hereinafter as DEPAL

Flame Retardant (Component B):

aluminum salt of phosphorous acid, referred to hereinafter as PHOPAL

Synergist (Component C):

melamine polyphosphate (referred to as MPP), Melapur® 200 (from Ciba SC, Switzerland)

melamine cyanurate (referred to as MC), Melapur® MC50 (from Ciba SC, Switzerland)

melem, Delacal® 420, Delacal® 360 (from Delamin Ltd, UK)

Component D:

zinc borate, Firebrake® ZB and Firebrake® 500, from Borax, USA

Boehmite: Apyral AOH 180, from Nabaltec, Germany

Phosphonites (Component E):

Sandostab® P-EPQ®, from Clariant GmbH, Germany

Wax Components (Component F):

Licomont® CaV 102, Clariant Produkte (Deutschland) GmbH, Germany (Ca salt of montan wax acid)

Licowax® E, from Clariant Produkte (Deutschland) GmbH, Germany (ester of montan wax acid)

2. Production, Processing and Testing of Flame-Retardant Polymer Molding Compositions

The flame retardant components were mixed with the phosphonite, the lubricants and stabilizers in the ratio specified in the table and incorporated via the side intake of a twin-screw extruder (Leistritz ZSE 27/44D) into N 6,6 at temperatures of 260 to 310° C., and into PBT at 250-275° C. The glass fibers were added via a second side intake. The homogenized polymer strand was drawn off, cooled in a water bath and then pelletized.

After sufficient drying, the molding compositions were processed to test specimens on an injection molding machine (Arburg 320 C Allrounder) at melt temperatures of 250 to 300° C., and tested and classified for flame retardancy using the UL 94 test (Underwriter Laboratories).

The UL 94 fire classifications are as follows:

V-0 afterflame time never longer than 10 sec, total of afterflame times for 10 flame applications not more than 50 sec, no flaming drops, no complete consumption of the specimen, afterglow time for specimens never longer than 30 sec after end of flame application

V-1 afterflame time never longer than 30 sec after end of flame application, total of afterflame times for 10 flame applications not more than 250 sec, afterglow time for specimens never longer than 60 sec after end of flame application, other criteria as for V-0

V-2 cotton indicator ignited by flaming drops, other criteria as for V-1.

Not classifiable (ncl): does not comply with fire classification V-2.

The flowability of the molding compositions was determined by finding the melt volume flow rate (MVR) at 275° C./2.16 kg. A sharp rise in the MVR value indicates polymer degradation.

All tests in the respective series, unless stated otherwise, were performed under identical conditions (temperature programs, screw geometry, injection molding parameters, etc.) for comparability.

The amounts stated in the tables which follow are parts by weight.

Table 1 shows how, by gradual replacement of DEPAL by aluminum phosphite, the afterflame time in the UL 94 test becomes much lower down to an aluminum phosphite content of 3.75% by weight. At higher aluminum phosphite content, the afterflame time rises again.

TABLE 1
N 6,6 GF 30 test results. C1 is a comparative example,
I1 to I4 inventive flame retardant-stabilizer mixture

| | C1 | I1 | I2 | I3 | I4 |
|---|---|---|---|---|---|
| Nylon-6,6 | 50 | 50 | 50 | 50 | 50 |
| 983 glass fibers | 30 | 30 | 30 | 30 | 30 |
| Component A: DEPAL | 20 | 18.75 | 17.5 | 16.25 | 15 |
| Component B: PHOPAL | | 1.25 | 2.5 | 3.75 | 5 |
| UL 94 0.8 mm | V-1 | V-0 | V-0 | V-0 | V-0 |
| Afterflame time in seconds | 29 | 16 | 10 | 6 | 12 |
| (10 flame applications) | | | | | |

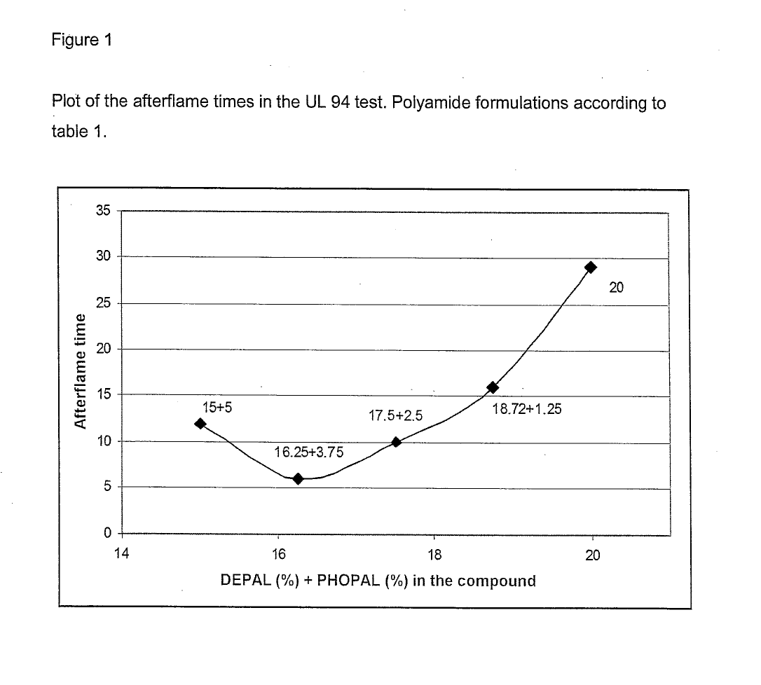

FIG. 1 shows the plot of the afterflame times in the UL 94 test. Polyamide formulations according to table 1.

Table 2 shows comparative examples C2 to C4, in which a flame retardant-stabilizer combination based on the aluminum salt of diethylphosphinic acid (DEPAL) and the nitrogen-containing synergist melamine polyphosphate (MPP) alone were used.

The results in which the flame retardant-stabilizer mixture according to the invention was used are listed in examples I5 to I7. All amounts are reported as % by weight and are based on the polymer molding composition including the flame retardant-stabilizer combination and additives.

TABLE 2
N 6,6 GF 30 test results. C2 to C4 are comparative examples,
I5 to I7 inventive flame retardant-stabilizer mixture

| | C2 | C3 | C4 | I5 | I6 | I7 |
|---|---|---|---|---|---|---|
| Nylon-6,6 | 49.55 | 49.55 | 49.55 | 49.55 | 49.55 | 49.55 |
| 983 glass fibers | 30 | 30 | 30 | 30 | 30 | 30 |
| A: DEPAL | 13 | 12 | 17 | 15 | 17 | 17 |
| B: PHOPAL | | | | 2 | 3 | 2 |
| C: MPP | 7 | 8 | 3 | 3 | | 1 |
| F: CaV 102 | 0.25 | 0.25 | 0.25 | 0.25 | 0.25 | 0.25 |
| E: P-EPQ | 0.20 | 0.20 | 0.20 | 0.20 | 0.20 | 0.20 |
| UL 94 0.8 mm | V-0 | V-0 | V-1 | V-0 | V-0 | V-0 |
| MVR 275° C./ | 19 | 21 | 12 | 5 | 3 | 4 |
| 2.16 kg | | | | | | |
| Exudation* | severe | marked | low | some | none | none |
| Color | gray | gray | white | white | white | white |
| Impact | 60 | 59 | 65 | 61 | 60 | 63 |
| resistance | | | | | | |
| [kJ/m²] | | | | | | |
| Notched impact | 12 | 11 | 13 | 14 | 15 | 12 |
| resistance | | | | | | |
| [kJ/m²] | | | | | | |

*14 days, 100% humidity, 70° C.

It is clear from examples I15, I6 and I7 that the inventive mixture of the DEPAL and PHOPAL and optionally melamine polyphosphate components distinctly improves the processibility of the polymers and the properties of the injection moldings, without impairing flame retardancy.

The incorporation of the DEPAL and MPP flame retardants into N 6,6 does lead to UL 94 V-0, but also to gray discoloration of the molding compositions, exudation and high melt indices (C2 and C3). Reducing the MPP content allows the gray discoloration to be prevented, and exudation declines significantly, but V-0 is not achieved either (C4).

If an inventive flame retardant-stabilizer combination of DEPAL and PHOPAL (I5, I6, I7) is now used, the result is not only flame retardancy but also no discoloration, no exudation, low melt indices and good mechanical properties. The low melt index (MVR) shows that there is no polymer degradation.

TABLE 3
Comparative examples DEPAL + melem or DEPAL +
zinc borate or DEPAL + boehmite and inventive
combinations of DEPAL and PHOPAL in nylon-6,6 GR

| | C5 | C6 | C7 | I8 | I9 | I10 |
|---|---|---|---|---|---|---|
| Nylon-6,6 | 49.55 | 49.55 | 49.55 | 49.55 | 49.55 | 49.55 |
| 983 glass fibers | 30 | 30 | 30 | 30 | 30 | 30 |
| A: DEPAL | 15 | 17 | 17 | 15 | 15 | 16 |
| B: PHOPAL | | | | 3 | 3 | 2 |
| C2: melem | 5 | | | 2 | | |
| D1: zinc borate | | 3 | | | 2 | 1 |
| D2: boehmite | | | 3 | | | 1 |
| F: CaV 102 | 0.25 | 0.25 | 0.25 | 0.25 | 0.25 | 0.25 |
| E: P-EPQ | 0.20 | 0.20 | 0.20 | 0.20 | 0.20 | 0.20 |
| UL 94 0.8 mm | V-1 | V-1 | V-1 | V-0 | V-0 | V-0 |
| MVR 275° C./ | 6 | 5 | 4 | 5 | 4 | 4 |
| 2.16 kg | | | | | | |
| Exudation* | marked | low | low | none | none | none |
| Color | yellow- | white | white | white | white | white |
| | ish | | | | | |
| Impact | 63 | 60 | 51 | 61 | 65 | 62 |
| resistance | | | | | | |
| [kJ/m²] | | | | | | |
| Notched impact | 15 | 16 | 9 | 14 | 15 | 11 |
| resistance | | | | | | |
| [kJ/m²] | | | | | | |

*14 days, 100% humidity, 70° C.

The incorporation of the DEPAL and melem or DEPAL and zinc borate or DEPAL and boehmite flame retardants into N-6,6 does lead to low exudation and low melt indices, but results not in a V-0 but only in a V-1 classification (C5, C6, C7). If an inventive flame retardant-stabilizer combination of DEPAL and PHOPAL with melem, zinc borate or boehmite (I8, I9, I10) is now used, the result is not only flame retardancy to UL 94 V-0 but also no discoloration, no exudation, low melt indices and good mechanical properties. The low melt index (MVR) shows that there is no polymer degradation.

TABLE 4
PBT GF 25 test results. C8-C10 are comparative examples,
I11-I13 inventive flame retardant-stabilizer mixture

| | C8 | C9 | C10 | I11 | I12 | I13 |
|---|---|---|---|---|---|---|
| PBT | 49.55 | 49.55 | 49.55 | 49.55 | 49.55 | 49.55 |
| 952 glass fibers | 25 | 25 | 25 | 25 | 25 | 25 |
| A: DEPAL | 13.3 | 12 | 12 | 12 | 12 | 12 |
| B: PHOPAL | | | | 5 | 4 | 4 |
| C1: MC | 7 | 7 | 7 | 3 | 3 | 3 |
| C2: MPP | | 1 | | | 1 | |
| C3: melem | | | 1 | | | 1 |
| E: Licowax E | 0.25 | 0.25 | 0.25 | 0.25 | 0.25 | 0.25 |
| F: P-EPQ | 0.20 | 0.20 | 0.20 | 0.20 | 0.20 | 0.20 |
| UL 94 0.8 mm | V-1 | V-1 | V-1 | V-0 | V-0 | V-0 |
| Solution | 1185 | 1201 | 1179 | 1375 | 1364 | 1338 |
| viscosity | | | | | | |
| SV* | | | | | | |
| Elongation at | 2.1 | 2.2 | 2.1 | 2.4 | 2.4 | 2.4 |
| break [%] | | | | | | |
| Impact | 40 | 41 | 39 | 49 | 48 | 47 |
| resistance | | | | | | |
| [kJ/m²] | | | | | | |
| Notched impact | 6.3 | 6.6 | 6.2 | 7.8 | 7.5 | 7.6 |
| resistance | | | | | | |
| [kJ/m²] | | | | | | |

*in dichloroacetic acid, pure PBT (uncompounded) gives 1450

The incorporation of DEPAL and MC and the further additives (examples C7, C8, C9) leads only to a V-1 classification and distinct polymer degradation, evident from the low solution viscosities. The mechanical values are also low compared to non-flame-retardant PBT. The inventive combination of DEPAL with PHOPAL and the further additives virtually completely suppresses polymer degradation; fire class V-0 is attained and the mechanical values are improved.

TABLE 5
N 6T/6,6 GF 30 test results. C11-C13 are comparative examples,
I14-I16 inventive flame retardant-stabilizer mixture

| | C11 | C12 | C13 | I14 | I15 | I16 |
|---|---|---|---|---|---|---|
| Nylon-6T/6,6 | 54.55 | 54.55 | 57.55 | 54.55 | 57.55 | 57.55 |
| 983 glass fibers | 30 | 30 | 30 | 30 | 30 | 30 |
| A: DEPAL | 15 | 13 | 12 | 14.5 | 10 | 9 |
| B: PHOPAL | | | | 0.5 | 2 | 1 |
| D: boehmite | | 2 | | | | 2 |
| F: CaV 102 | 0.25 | 0.25 | 0.25 | 0.25 | 0.25 | 0.25 |
| E: P-EPQ | 0.20 | 0.20 | 0.20 | 0.20 | 0.20 | 0.20 |
| UL 94 0.8 mm | V-0 | V-0 | V-1 | V-0 | V-0 | V-0 |
| Corrosion* | marked | n.d. | n.d. | low | n.d. | n.d. |
| Impact | 40 | 35 | 45 | 41 | 46 | 40 |
| resistance | | | | | | |
| [kJ/m²] | | | | | | |
| Notched impact | 8 | 6 | 12 | 8 | 13 | 9 |
| resistance | | | | | | |
| [kJ/m²] | | | | | | |

*corrosion was determined by the lamina method described in WO 2009/109318.

Table 5 shows that the inventive combination of DEPAL and PHOPAL gives a V-0 classification with much better mechanical values than without the PHOPAL addition. Small additions of PHOPAL distinctly reduce the corrosion observed with DEPAL in N 6T/6,6.

TABLE 6
N-4,6 GF 30 test results. C14-C15 are comparative examples,
I17-I18 inventive flame retardant-stabilizer mixture

| | C14 | C15 | I17 | I18 |
|---|---|---|---|---|
| Nylon-4,6 | 50 | 48 | 52 | 30 |
| 995 glass fibers | 30 | 30 | 30 | 30 |
| A: DEPAL | 20 | 18 | 15 | 15 |
| B: PHOPAL | | | 3 | 5 |
| D1: zinc borate | | 4 | | |
| UL 94 0.8 mm | V-1 | V-1 | V-0 | V-0 |
| Afterflame time in seconds | 164 | 131 | 29 | 33 |
| (10 flame applications) | | | | |
| UL 94 1.6 mm | V-1 | V-1 | V-0 | V-0 |
| Afterflame time in seconds | 147 | 103 | 12 | 13 |
| (10 flame applications) | | | | |

Glass fiber-reinforced nylon-4,6 can be rendered flame-retardant with DEPAL or DEPAL and zinc borate, as shown by comparative examples C14-C15 in table 6. However, in the UL 94 test with an amount of flame retardant of 20-22% by weight, only the V-1 classification with long afterflame times is attainable. The inventive flame retardant-stabilizer mixture in N 4,6 GF30 exhibits much higher flame retardancy, and so a smaller use amount of 18-20% by weight can reliably be expected to attain the higher UL 94 class V-0, as evident in examples I17 and I18 in table 6.

1. A flame retardant-stabilizer combination for a thermoplastic polymer, comprising as component A 20 to 99% by weight of a dialkylphosphinic salt of the formula (I), a diphosphinic salt of the formula (II) polymers thereof or mixtures thereof 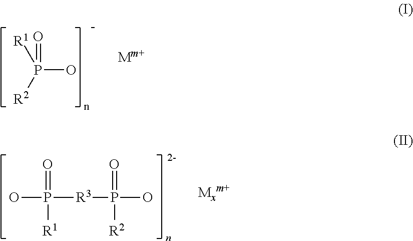
wherein
R¹, R² are the same or different and are each linear or branched C₁-C₆-alkyl;
R³ is linear or branched C₁-C₁₀-alkylene, C₆-C₁₀-arylene, C₇-C₂₀-alkylarylene or C₇-C₂₀-arylalkylene;
M is Mg, Ca, AI, Sb, Sn, Ge, Ti, Zn, Fe, Zr, Ce, Bi, Sr, Mn, Li, Na, K, a protonated nitrogen base or a mixture thereof;
m is 1 to 4;
n is 1 to 4;
x is 1 to 4,
as component B 1 to 80% by weight of a salt of phosphorous acid of the formula (III)
[HP(═O)O₂]²⁻M ^{m+} (III)
wherein
M is Mg, Ca, Al, Sb, Sn, Ge, Ti, Zn, Fe, Zr, Ce, Bi, Sr, Mn, Li, Na, K or a mixture thereof;
m is 1 to 4,
as component C 0 to 30% by weight of a nitrogen-containing synergist, a phosphorus/nitrogen flame retardant or a mixture thereof,
as component D 0 to 10% by weight of a zinc salt a basic oxide, amphoteric oxide, hydroxide, carbonate, silicate, borate, stannate, mixed oxide-hydroxide, oxide-hydroxide-carbonate, hydroxide-silicate, hydroxide-borate or a mixture thereof,
as component E 0 to 3% by weight of a phosphonite or a mixture of a phosphonite and a phosphite, and as component F 0 to 3% by weight of an ester a salt of long-chain aliphatic carboxylic acids (fatty acids) having a chain length of C₁₄ to C₄₀ or a mixture thereof, where the sum of the components is always 100% by weight.

2. The flame retardant-stabilizer combination as claimed in claim 1, wherein R¹, R² are the same or different and are each methyl, ethyl, n-propyl, isopropyl, n-butyl, tert-butyl, n-pentyl, and/or phenyl or a mixture thereof.

3. The flame retardant-stabilizer combination as claimed in claim 1, wherein R³ is methylene, ethylene, n-propylene, isopropylene, n-butylene, tert-butylene, n-pentylene, n-octylene or n-dodecylene; phenylene; naphthylene; methylphenylene, ethylphenylene, tert-butylphenylene, methylnaphthylene, ethylnaphthylene or tert-butylnaphthylene; phenylmethylene, phenylethylene, phenylpropylene or phenyibutylene.

4. The flame retardant-stabilizer combination as claimed in claim 1, comprising
60 to 89.9% by weight of component A,
10 to 40% by weight of component B,
0 to 30% by weight of component C,
0 to 15% by weight of component D,
0 to 2% by weight of component E and
0.1 to 2% by weight of component F.

5. The flame retardant-stabilizer combination as claimed in claim 1, comprising
60 to 84.9% by weight of component A,
10 to 40% by weight of component B,
5 to 30% by weight of component C,
0 to 10% by weight of component D,
0 to 2% by weight of component E and
0.1 to 2% by weight of component F.

6. The flame retardant-stabilizer combination as claimed in claim 1, comprising
60 to 84.8% by weight of component A,
10 to 40% by weight of component B,
5 to 30% by weight of component C,
0 to 10% by weight of component D,
0.1 to 2% by weight of component E and
0.1 to 2% by weight of component F.

7. The flame retardant-stabilizer combination as claimed in claim 1, wherein component B comprises reaction products of phosphorous acid with aluminum compounds.

8. The flame retardant-stabilizer combination as claimed in claim 1, wherein component B comprises aluminum phosphite [Al(H₂PO₃)₃], secondary aluminum phosphite [Al₂(HPO₃)₃], basic aluminum phosphite [Al(OH)(H₂PO₃)₂*2aq], aluminum phosphite tetrahydrate [Al₂(HPO₃)₃*4aq], aluminum phosphonate, Al₇(HPO₃)₉(OH)₆(1,6-hexanediamine)_{1.5}*12H₂O, Al₂(HPO₃)³*xAl₂O₃*nH₂O where x=2.27-1, Al₄H₆P₁₆O₁₈ or mixtures thereof.

9. The flame retardant-stabilizer combination as claimed in claim 1, wherein component C comprises condensation products of melamine, reaction products of melamine with polyphosphoric acid, reaction products of condensation products of melamine with polyphosphoric acid or mixtures thereof.

10. The flame retardant-stabilizer combination as claimed in claim 1, wherein component C comprises melem, melam, melon, dimelamine pyrophosphate, melamine polyphosphate, melem polyphosphate, melam polyphosphate, melon polyphosphate or mixed poly salts thereof or mixtures thereof.

11. The flame retardant-stabilizer combination as claimed in claim 1, wherein component C comprises nitrogen-containing phosphates of the formulae (NH₄)_{y}H_{3-y}PO₄ and (NH₄PO₃)_{z}, where y is 1 to 3 and z is 1 to 10 000.

12. The flame retardant-stabilizer combination as claimed in claim 1, wherein component D comprises magnesium oxide, calcium oxide, aluminum oxide, zinc oxide, manganese oxide, tin oxide, aluminum hydroxide, boehmite, dihydrotalcite, hydrocalumite, magnesium hydroxide, calcium hydroxide, zinc hydroxide, tin oxide hydrate, manganese hydroxide, zinc borate, basic zinc silicate, zinc stannate or mixtures thereof.

13. The flame retardant-stabilizer combination as claimed in claim 1, wherein the phosphonites comprise those of the structure
R—[P(OR₁)₂]ₘ (IV)
wherein
R is a mono- or polyvalent aliphatic, aromatic or heteroaromatic organic radical and
R₁ is a compound of the structure (V) 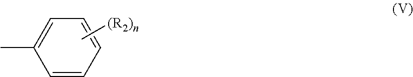
or the two R₁ radicals form a bridging group of the structure (VI) 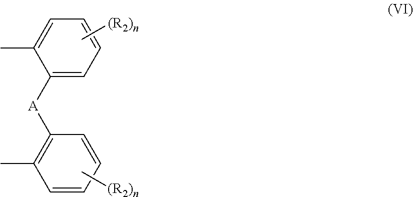
wherein
A is a direct bond, O, S, C₁-C₁₈-alkylene (linear or branched), C₁-C₁₈-alkylidene (linear or branched), in which
R₂ is independently C₁-C₁₂-alkyl (linear or branched), C₁-C₁₂-alkoxy, C₅-C₁₂-cycloalkyl and
n is 0 to 5 and
m is 1 to 4.

14. The flame retardant-stabilizer combination as claimed in claim 1, wherein component F comprises alkali metal, alkaline earth metal, aluminum or zinc salts of long-chain fatty acids having 14 to 40 carbon atoms, reaction products of long-chain fatty acids having 14 to 40 carbon atoms with polyhydric alcohols or mixtures thereof.

15. A flame-retardant polymer molding composition comprising a flame retardant-stabilizer combination wherein the flame retardant-stabilizer combination comprises as component A
20 to 99% by weight of a dialkylphosphinic salt of the formula (I), a diphosphinic salt of the formula (II) polymers thereof or mixtures thereof 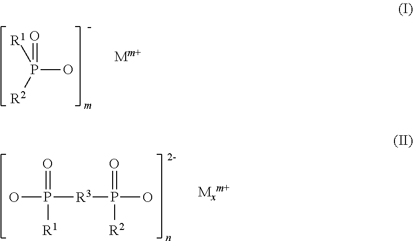
wherein
R¹, R² are the same or different and are each linear or branched C₁-C₆-alkyl;
R³ is linear or branched C₁-C₁₀-alkylene, C₆-C₁₀-arylene, or C₇-C₂₀-arylalkylene;
M is Mg, Ca, Al, Sb, Sn, Ge, Ti, Zn, Fe, Zr, Ce, Bi, Sr, Mn, Li, Na, K, a protonated nitrogen base or a mixture thereof;
m is 1 to 4;
n is 1 to 4;
x is 1 to 4,
as component B 1 to 80% by weight of a salt of phosphorous acid of the formula (III)
[HP(═O)O₂]²⁻M ^{m+} (III)
wherein
M is Mg, Ca, Al, Sb, Sn, Ge, Ti, Zn, Fe, Zr, Ce, Bi, Sr, Mn, Li, Na, K or a mixture thereof;
m is 1 to 4,
as component C 0 to 30% by weight of a nitrogen-containing synergist, a phosphorus/nitrogen flame retardant or a mixture thereof,
as component D 0 to 10% by weight of a zinc salt, a basic oxide, amphoteric oxide, hydroxide, carbonate, silicate, borate, stannate, mixed oxide-hydroxide, oxide-hydroxide-carbonate, hydroxide-silicate, hydroxide-borate or a mixture thereof,
as component E 0 to 3% by weight of a phosphonite or a mixture of a phosphonite and a phosphite, and as component F 0 to 3% by weight of an ester, a salt of long-chain aliphatic carboxylic acids (fatty acids) having a chain length of C₁₄ to C₄₀ or a mixture thereof, where the sum of the components is always 100% by weight and wherein the polymer comprises thermoplastic polymers or elastomers of the HI (high-impact) polystyrene, polyphenylene ether, polyamide, polyester or polycarbonate type, blends or polymer blends of the ABS (acrylonitrile-butadiene-styrene) or PC/ABS (polycarbonate/acrylonitrile-butadiene-styrene) or PPE/HIPS (polyphenylene ether/HI polystyrene) polymer type, and the polymer molding composition comprises the flame retardant-stabilizer combination in an amount of 2 to 50% by weight, based on the polymer molding composition.

16. A polymer molding, film, filament or fiber comprising a flame retardant-stabilizer combination, wherein the flame-stabilizer composition includes as component A
20 to 99% by weight of a dialkylphosphinic salt of the formula (I), a diphosphinic salt of the formula (II) polymers thereof or mixtures thereof 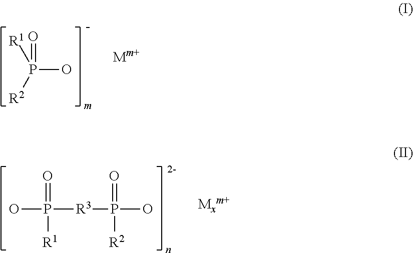
wherein
R¹, R² are the same or different and are each linear or branched C₁-C₆-alkyl;
R³ is linear or branched C₁-C₁₀-alkylene, C₆-C₁₀-arylene, C₇-C₁₀-alkylarylene or C₇-C₂₀-arylalkylene;
M is Mg, Ca, Al, Sb, Sn, Ge, Ti, Zn, Fe, Zr, Ce, Bi, Sr, Mn, Li, Na, K, a protonated nitrogen base or a mixture thereof;
m is 1 to 4;
n is 1 to 4;
x is 1 to 4,
as component B 1 to 80% by weight of a salt of phosphorous acid of the formula (III)
[HP(═O)O₂]²⁻M^{m+} (III)
wherein
M is Mg, Ca, Al, Sb, Sn, Ge, Ti, Zn, Fe, Zr, Ce, Bi, Sr, Mn, Li, Na, K or a mixture thereof;
m is 1 to 4,
as component C 0 to 30% by weight of a nitrogen-containing synergist, a phosphorus/nitrogen flame retardant or a mixture thereof,
as component D 0 to 10% by weight of a zinc salt, a basic oxide, amphoteric oxide, hydroxide, carbonate, silicate, borate, stannate, mixed oxide-hydroxide, oxide-hydroxide-carbonate, hydroxide-silicate, hydroxide-borate or a mixture thereof,
as component E 0 to 3% by weight of a phosphonite or a mixture of a phosphonite and a phosphite, and as component F 0 to 3% by weight of an ester, a salt of long-chain aliphatic carboxylic acids (fatty acids) having a chain length of C₁₄ to C₄₀ or a mixture thereof, where the sum of the components is always 100% by weight and wherein the polymer comprises HI (high-impact) polystyrene, polyphenylene ethers, polyamides, polyesters or polycarbonates, blends or polymer blends of the ABS (acrylonitrile-butadiene-styrene) or PC/ABS (polycarbonate/acrylonitrile-butadiene-styrene) type, polyamide, polyester and/or ABS and/or elastomers, and this polymer molding, film, filament or fiber comprises the flame retardant-stabilizer combination in an amount of 2 to 50% by weight, based on the polymer molding, film, filament or fiber.

17. A flame-retardant polymer molding composition as claimed in claim 15, wherein the polymer comprises polyamides, polyesters or mixtures thereof.

18. The flame retardant-stabilizer composition as claim in claim 14, wherein the reaction products of long-chain fatty acids having 14 to 40 carbon atoms with polyhydric alcohols are ethylene glycol, glycerol, trimethylolpropane, pentaerythritol or mixtures thereof.

19. A flame-retardant polymer molding, film, filament or fiber as claimed in claim 16, wherein the polymer comprises polyamides, polyesters or a mixture thereof.
